(19) United States
(12) Patent Application Publication
(10) Pub. No.: US 2017/0004232 A9
(43) Pub. Date: Jan. 5, 2017

(54) DEVICE AND METHOD FOR ACCELERATING THE UPDATE PHASE OF A SIMULATION KERNEL

(71) Applicant: COMMISSARIAT A L'ENERGIE ATOMIQUE ET AUX ENERGIES ALTERNATIVES, Paris (FR)

(72) Inventors: Nicolas VENTROUX, Massy (FR); Tanguy SASSOLAS, Paris (FR)

(21) Appl. No.: 14/768,393

(22) PCT Filed: Feb. 5, 2014
(86) PCT No.: PCT/EP2014/052245

§ 371 Date: Aug. 17, 2015

(30) Foreign Application Priority Data
Feb. 15, 2013 (FR) 1351322

(51) Int. Cl. G06F 17/50

(52) U.S. Cl. CPC G06F 17/509

(57) ABSTRACT

A method for accelerating the updating of the linking elements in a simulation of a system generated according to a given hardware description language, the method comprising a phase for evaluating the eligible processes of the system, the evaluation phase comprising write or read accesses to linking elements. For each linking element, two write memory locations are provided. The evaluation phase comprises the updating of a linking element for each write or read access of the linking element. The update comprises the following steps: receive a selection word associated with the linking element; select one of the two write locations associated with the linking element depending on the value of the selection word received for the linking element; and update the current value of the linking element based on the write memory location selected.

### TECHNICAL FIELD

The present invention relates, in a general manner, to prototyping tools for the simulation and the exploration of systems to be designed and, in particular, a device and a method for accelerating the update phase of a simulation kernel.

### PRIOR ART AND TECHNICAL PROBLEM

While the complexity of semiconductors continues to grow, the use of integrated circuits has undergone a significant advance in all fields. Systems-on-a-Chip, generally denoted by the acronym SoC, have thus become indispensible elements in many products. The design of such systems requires, amongst other things, the execution of the application code on the hardware platform to be validated before its final design. Since the costs of the design and fabrication phase are too high to be able to carry out several tests, the entirety of the system must be able to be validated prior to its fabrication, and this must be done in the shortest time possible. Thus, high-level modeling tools have been developed that are capable of modeling the software and hardware parts of a complex system, and that allow both software prototyping together with architectural exploration.

The use of such software platforms during the design phase has become indispensible. These software platforms allow the development of the low-level software (drivers, operating system, etc.) to be facilitated, or else architectural exploration to be carried out. Architectural exploration is an optimization phase which allows the size and the characteristics of the various elements belonging to the system to be defined, such as the size or the type of the cache memories, or again for example the size of the links of the interconnection networks. More recently, means have been added to the prototyping tools for studying the energy consumption, or for example the temperature. The possibility of having all these types of information available very early in the design process offers very many advantages which have a direct effect on the competitivity of the final product. It allows for example better architectural choices to be made in order to enhance the performance characteristics and the energy efficiency, or even better to run the various design phases in parallel in order to considerably reduce the design time.

A large majority of the software prototyping tools is based on the hardware description language SystemC and also on its extension known as Transactional Level Modeling (TLM). These two elements form part of the standard IEEE 1666™-2011. More precisely, SystemC is a free access C/C++ library comprising a specific grammar allowing the modeling of software and hardware electronic systems. SystemC is also based on a kernel capable of sequencing, in a cooperative manner, processes representing the various concurrent elements of a system. Since the SystemC simulations are sequential, the virtual prototyping solutions are not able to exploit the parallelism of the machines supporting their execution. The simulation times therefore increase directly with the complexity of the simulated models.

Still a few years ago, the design of a system used the implementation of a prototyping software solution capable of executing its application code and also of supporting the architectural exploration. One and the same model served as a single platform for the software (driver, system software, etc.) and hardware design. These simulators integrated the conventional design flow guaranteeing a unified flow from the applications up to the hardware.

More recently, the complexity of the systems to be designed has become such that, today, two software platforms are most often used. The software prototypes, as simulator for the application development, are now differentiated from the hardware prototypes, for the exploration, the analysis and the architectural design. This separation is mainly due to the fact that the hardware prototypes have become too slow for the application development. In contrast, a greater abstraction of the behavior of the platform or of the time-dependent information allows the simulation times to be significantly reduced. However, such an approach has its limits. Indeed, since the systems are becoming ever more complex, it will not always be possible to improve the simulation times by reducing the precision. Furthermore, the loss of information and of precision from the models used in the development of the software introduces irrecoverable errors in the design flow.

The acceleration of the SystemC simulations may be carried out at several levels. First of all, it is possible to optimize the sequencing of the SystemC processes, such as for example in:
N. Savoiu, S. K. Shukla and R. K. Gupta, “Design for synthesis, transformation for simulation: Automatic transformation of threading structures in high-level system models”, UC irvine Technical Report, 2001;
G. Mouchard, D. Gracia Perez, and O. Temam, “FastSysC: A Fast Simulation Engine,” Design, Automation and Test in Europe (DATE), Paris, France, 2004;
Y. N. Naguib and R. S. Guindi, “Speeding up SystemC simulation through process splitting”, Proceedings of the conference on Design, automation and test in Europe, Nice, France: EDA Consortium, 2007, p. 111-116;
R. Buchmann and A. Greiner, “A Fully Static Scheduling Approach for Fast Cycle Accurate SystemC Simulation of MPSoCs”, International Conference on Microelectronics (ICM), Cairo, Egypt, December 2007, pp. 105-108.

The aim of these solutions is to reduce the additional costs due to the synchronizations and changes in context by analyzing the dependences between the processes and by applying a static sequencing. However, in the case where this evaluation does not have the same behavior as a function of its inputs or of the data that it handles, the optimum order for evaluation of the processes may be modified and imposing a static sequencing may lead to a significant loss of performance (S. Sirowy, C. Huang and F. Wahid, “Online SystemC Emulation Acceleration”, IEEE Design Automation Conference (DAC), Anaheim, USA, June 2010).

Other solutions provide for running the evaluation of the processes in parallel on distributed structures, such as for example:
A. Mello, I. Maia, A. Greiner, and F. Pecheux, “Parallel simulation of SystemC TLM 2.0 compliant MPSoC on SMP workstations”, Proceedings of the conference on Design, Automation and Test in Europe (DATE), pages 606-609, 2010;
P. Ezudheen, P. Chandran, J. Chandra, B. P. Simon, and D. Ravi, “Parallelizing SystemC kernel for fast hardware simulation on SMP machines”, IEEE Workshop on Principles of Advanced and Distributed Simulation, (PADS) Lake Placid, N.Y., USA, June 2009, pp. 80-87;
V. Galiano, H. Migallón, D. Perez-Caparrós, and M. Martinez, “Distributing SystemC structures in parallel simulations”, Spring Simulation Multiconference, San Diego, USA, 2009, pp 1-8.

However, the solutions provided are rapidly degraded with the increase in the communications between the processes.

Another known solution, described in FR2971596, consists in accelerating the execution of the SystemC kernel. For this, an assembly of hardware means are provided for the acceleration of SystemC simulations on multicore platforms. These means are used to accelerate the management of the time and of the events. FR2971596 furthermore provides a dynamic sequencing of the processes over an assembly of processing resources. This solution offers useful results, but only allows the phase for execution of the SystemC kernel to be improved.

In yet other solutions, the idea is to distribute several copies of the SystemC kernel over several data processing computers or servers using network communications techniques of already widely used in parallel data processing:
A. Mello, I. Maia, A. Greiner, and F. Pecheux, “Parallel Simulation of SystemC TLM 2.0 Compliant MPSoC on SMP Workstations”, IEEE conference on Design, Automation and Test in Europe (DATE), Dresden, Germany, March 2010;
P. Combes, E. Caron, F. Desprez, B. Chopard, and J. Zory, “Relaxing Synchronization in a Parallel SystemC Kernel”, Proceedings of the 2008 IEEE International Symposium on Parallel and Distributed Processing with Applications, IEEE Computer Society, 2008, p. 180-187;
H. Ziyu, Q. Lei, L. Hongliang, X. Xianghui, and Z. Kun, “A Parallel SystemC Environment: ArchSC”, IEEE International Conference on Parallel and Distributed Systems (ICPADS), Shenzhen, China, December 2009;
B. Chopard, P. Combes, and J. Zory, “A Conservative Approach to SystemC Parallelization”, ICCS 2006 Proceedings, V. A. Alexandrov and Dongarra, Ed., Springer-Verlag, 2006, p. 653-660.

However, in this approach, the communication times lead to a very high time penalty such that it is then necessary to assemble the most dependent processes into the same group (or ‘cluster’). The efficacy of such an approach therefore requires having very few inter-cluster communications and consequently assumes significant constraints on dependences between the processes. Thus, in the article “Parallel Simulation of SystemC TLM 2.0 Compliant MPSoC on SMP Workstations” (IEEE conference on Design, Automation and Test in Europe (DATE), Dresden, Germany, March 2010, of A. Mello, I. Maia, A. Greiner, and F. Pecheux), the idea is to make parallel operation explicit within the architecture so as to subsequently favor its evaluation on massively paralleled machines. This solution does not allow any given type of architecture to be explored and simulated.

In another approach, other execution media are used. Such a solution is described for example in the following article: M. Nanjundappa, H. D. Patel, B. A. Jose, and S. K. Shukla, “SCGPSim: A fast SystemC simulator on GPUs”, IEEE Design Automation Conference (ASP-DAC), Taipei, Taiwan, January 2010. In this article, the idea is to use graphics processors as parallel machines in order to accelerate the execution of SystemC simulations at the RTL level. For this, the SystemC kernel is modified so as to render concurrent the evaluation of the processes by virtue of a double storage in buffer memory of the variables and of the output signals. Subsequently, each process described in synthesizable SystemC is transformed into CUDA language in order to be able to be executed on the processing units of the graphics processor. However, such solutions involve significant modifications of the SystemC kernel not conforming to the standard. They pose difficulties both for tracing and setting up the simulator and also for validating the execution model. Furthermore, they impose constraints in the description of the SystemC processes which must be synthesizable. They do not therefore support transactional communications, and the number of different processes able to be executed in parallel is limited. Lastly, the access to the global memory, needed for each synchronization between the processes, is adversely affected by a very high latency.

Other articles take a similar approach by trying to transfer their simulator onto the IBM CELL processor: L. Kaouane, D. Houzet, S. Huet, “SysCelIC: SystemC on Cell”, IEEE International Conference on Computational Sciences and Its Applications (ICCSA), Le Havre, France, June 2009. For this purpose, FIFO primitives and the signals present in the SystemC library have been modified so as to incorporate into them, in an abstract manner, the communications protocol used in the CELL architecture. Thus, all the SystemC processes must communicate with one another via FIFO or SystemC signals. The transactional communications are therefore not supported. In order to distribute the SystemC processes over the various secondary processors of the CELL architecture, a static partitioning tool based on a preliminary study of the profiles of the processes is used. Finally, in order to limit the communications with the main processor, a part of the SystemC kernel is distributed between all the secondary processors with the aim of locally sequencing the groups of allocated processes. Furthermore, significant modifications of the simulator are carried out and significant constraints within the architecture implemented are imposed. These deficiencies are considerably detrimental to the potential for exploration of the design domain of systems-on-a-chip and prevent the setting up of the simulator according to the code generated by the programmer. Furthermore, no dynamic migration or allocation of processes is possible. As a consequence, this static approach does not allow evaluations of processes whose execution is dynamic to be taken into account and can lead in this case to a significant reduction in performance.

Another approach involves the use of specific hardware elements for accelerating the execution of the SystemC simulations, as described in:
“Multi-core processor satisfying SystemC syntax”, Institute of Computing Technology, Chinese Academy of Sciences, CN101634979, 27 Jan. 2010, China.
“Event processing unit group of multi-core processor conforming to SystemC grammar”, Institute of Computing Technology, Chinese Academy of Sciences, CN101315648, 12 Mar. 2008, China.
“First-in first-out queue unit set of multi-core processor satisfying SystemC grammar”, Institute of Computing Technology, Chinese Academy of Sciences, CN101329702, 24 Dec. 2008, China.
“Mutual exclusion and semaphore cell block of multi-core processor satisfying SystemC syntax”, Institute of Computing Technology, Chinese Academy of Sciences, CN101635006, 27 Jan. 2010, China.
“SystemC processor to meet the dynamic processes”, Institute of Computing Technology, Chinese Academy of Sciences, CN101770362, 7 Jul. 2010, China.
“Multi-core processor meeting SystemC grammar request and method for acquiring performing code”, Institute of Computing Technology, Chinese Academy of Sciences, CN101196826, 11 Jun. 2010, China.

According to this approach, hardware units, in conjunction with a RISC processor, capable of emulating primitives or SystemC functions are used to accelerate the simulations. They support for example the dynamic management of processes (SC_SPAWN), semaphores and mutex, FIFOs and the management of lists of sensitivity and of events. In addition, special units for the exchange of data between processes are used to store the values of the signals. Here again, a static allocation of the processes and a substantial modification of the simulators for the use of the hardware primitives are provided. Furthermore, the limited number of units associated with each of the processors severely constrains the modeling possibilities.

In another approach provided for educational purposes, SystemC simulations are emulated on an FPGA board at the RTL level, as described in:
S. Sirowy, C. Huang and F. Wahid, “Portable SystemC-on-a-Chip”, IEEE CODES+ISSS, Grenoble, France, October 2009
S. Sirowy, C. Huang and F. Wahid, “Dynamic Acceleration Management for SystemC Emulation”, HIPEAC workshop APRES, Grenoble, France, October 2009
S. Sirowy, C. Huang and F. Wahid, “Online SystemC Emulation Acceleration”, IEEE Design Automation Conference (DAC), Anaheim, USA, June 2010.

Each of the units possesses a pre-defined interface comprising a limited number of inputs and outputs. Each of these units also has access to specific memories for storing its data, its instructions and the values of the signals. Furthermore, in order to remain independent of the FPGA platform, the generation of a generic executable program and a virtualization technique for its execution have been chosen. Thus, a hardware emulation engine is added to the emulation unit for accelerating the execution of the generic executable program. In this latter solution, the use of a virtualization technique provides flexibility but considerably increases the complexity of the code to be executed. Furthermore, imposing a particular interface considerably reduces the exploration space and is not suitable for the design of architectures. Furthermore, the transactional model is still not supported and no means of setting up or of tracing is possible.

### GENERAL DEFINITION OF THE INVENTION

The aim of the invention is to improve the situation by providing a method for accelerating the updating of the linking elements in a simulation of a system generated according to a given hardware description language, the method comprising a phase for evaluation of the eligible processes of the system, and the evaluation phase comprising write and read accesses to linking elements. Advantageously, for each linking element, two write memory locations are initially provided, whereas the evaluation phase comprises the updating of a linking element for each write or read access of the linking element, the update comprising the following steps:

receive a selection word associated with the linking element;

select one of the two write locations associated with the linking element depending on the value of the selection word received for the linking element; and

update the current value of the linking element based on the selected write memory location.

The simulations progress by a succession of evaluation and of update phases; during these phases, the read operations of the linking elements return a constant value called current value at the same time as processes write new values onto this linking element. At the end of the update phase, the last value written onto a linking element becomes the current value of the following evaluation phase.

In one particular embodiment, the selection word is a parity bit.

According to one aspect of the invention, the updating of the linking elements is carried out in parallel during the evaluation phase.

The method may furthermore comprise requests for a change of state of the selection words associated with the linking elements, the requests being carried out in parallel during the evaluation phase.

According to another aspect of the invention, the selection words associated with the linking elements remain constant during the evaluation phase

According to one feature of the invention, for an access to a linking element of the read type, the updating of the linking element comprises the following steps:

receive the value of the selection word for the linking element,

update the current value of the linking element from a write memory location determined according to the value of the selection word received, and

return the new current value.

According to another feature of the invention, for an access to a linking element of the write type, the step for updating the linking element comprises the following steps:

receive the value of the selection word for the linking element,

update the current value of the linking element from a write memory location determined according to the value of the selection word received,

write the new value of the linking element into the write memory location distinct from the write memory location determined according to the value of the selection word received.

As a complement, the method may comprise a delta notification request for the evaluation of the sensitive processes on the linking element if the new value of the linking element is different from the current value of the linking element.

The method may furthermore comprise the generation of a request for updating the selection word associated with the linking element.

In particular, the step for updating the selection word may comprise an update of the selection word to a value opposite to that of the selection word.

In one embodiment of the invention, the hardware description language is SystemC.

The linking elements may also comprise at least one from amongst the following SystemC elements: signals “sc_signal”, signals “sc_signal_resolved”, signals “sc_signal_rv”, buffer memories “sc_buffer”.

The invention furthermore provides a device for accelerating the updating of the linking elements in a simulation of a system generated according to a given hardware description language, the device comprising a phase for evaluation of the eligible processes of the system. The device comprises an evaluation unit for evaluating processes, the evaluation comprising write or read accesses for linking elements. Advantageously, the device comprises two write memory locations for each linking element, whereas the evaluation unit comprises, in response to a read or write access for a linking element, a call to an update function designed to update the linking element, the update function being configured for:

receiving a selection word associated with a linking element to be modified;

selecting one of the two write locations associated with the linking element depending on the value of the selection word received for the linking element; and

updating the current value of the linking element based on the write memory location selected.

According to one feature of the invention, the device may comprise a hardware module configured for delivering the selection word associated with each linking element and for updating the selection words.

The invention thus enables the simulations to be accelerated in such a manner that the virtual prototypes can maintain a high precision, while at the same time being sufficiently fast for the application development, the architectural exploration or the functional verification. The invention also contributes to unifying the virtual software and hardware prototypes. This results in a reduction of the design times and hence in the development costs.

The invention furthermore allows the time spent in the SystemC kernel to be reduced, a fact which has the effect of reducing the extra cost due to the sequential execution of the SystemC kernel. Furthermore, the invention allows the non-parallelizable part to be reduced in order to maximize the gain obtained by the parallelization.

More generally, the invention enables the SystemC simulations to be accelerated for both the virtual hardware and software prototypes.

### BRIEF DESCRIPTION OF THE DRAWINGS

Other features and advantages of the invention will become apparent with the aid of the description that follows and of the figures of the appended drawings in which:

FIG. 1 shows the software architecture of the SystemC library;

FIG. 2A shows the conventional method of sequencing of the SystemC kernel;

FIG. 2B shows the method of sequencing of the SystemC kernel, according to the invention;

FIG. 3 is an operational diagram of the simulation SystemC kernel, according to one embodiment of the invention;

FIG. 4 is a flow diagram representing the various steps implemented for updating a SystemC linking element during the evaluation of the processes involving a read on the SystemC linking element;

FIG. 5 is a flow diagram representing the various steps implemented for updating a SystemC linking element during the evaluation of the processes involving a write onto the SystemC linking element; and

FIG. 6 shows the structure of the update hardware module, according to one embodiment of the invention.

The drawings and the appendices to the description comprise, for the most part, elements that are certain. They will therefore not only serve for a better understanding of the description, but will also contribute to the definition of the invention, where appropriate.

The reference to certain software entities in the description imposes certain notation conventions. In particular, an expression in italics and/or quotation marks will be used in the description hereinafter in order to identify an element of the SystemC library, the name of a SystemC structural element, or else software elements used by the invention.

### DETAILED DESCRIPTION

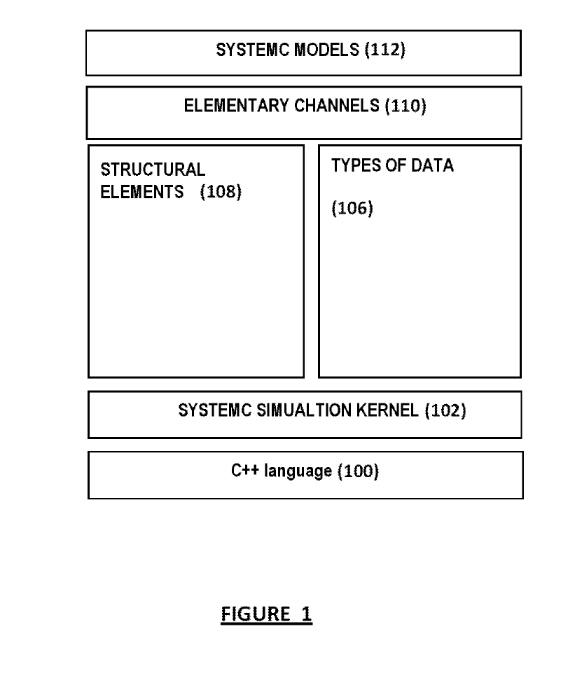

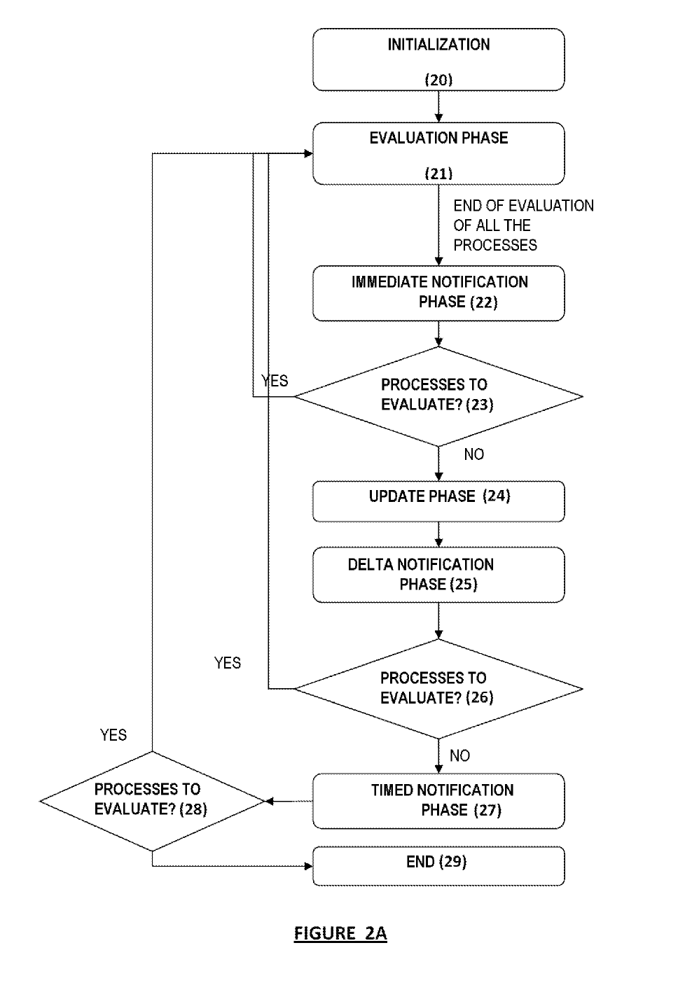

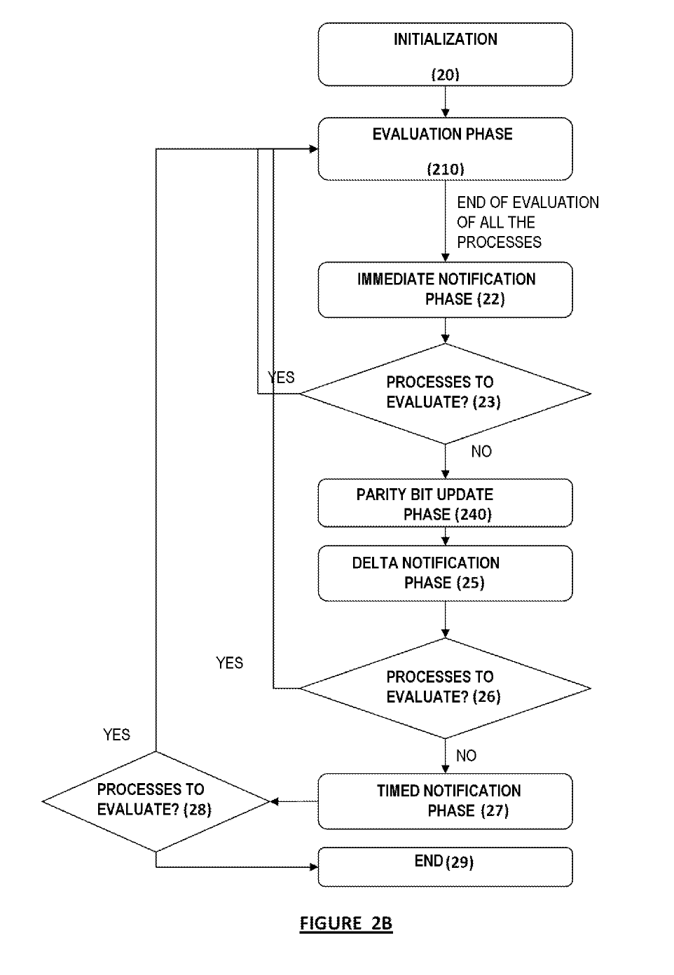

Although the reader is assumed to be familiar with the SystemC environment, certain notions are recalled hereinafter in relation with FIG. 1 and FIG. 2A in order to facilitate the understanding of the present invention.

FIG. 1 shows the software architecture of the SystemC library. This architecture is organized in layers. The layer 100 corresponds to the layer C++ which represents the basic technology on which the implementation of SystemC relies. The layer 102 represents the simulation SystemC kernel. The SystemC kernel is based on a cooperative sequencing and the notion of “delta” cycle for modeling the concurrence between the constituent elements of the simulator. The layer 106 represents the types of data. These data types include both the types associated with the software programming and the types associated with the description of the hardware.

The layer 108 represents the structure used in SystemC for describing the hardware system. The SystemC library has a set of classes and methods for the hardware modeling and the description of system-level behaviors. With the SystemC hardware description language, a hardware system is represented as a hierarchy of objects comprising nested modules and/or processes. The modules communicate with one another via channels. The highest element in the hierarchy of a complete system is the SystemC function “sc_main”. In the function sc_main, the modules are created and connected together, and the simulation is subsequently launched. The program is finally compiled which generates an executable program program representing the behavior of the system.

The modules are the highest level components in the SystemC hierarchy. A module may contain ports which allow communications with other modules and indirectly with the processes that describe the functionality of the module. The ports represent the input/output points of the modules. A module may contain other modules.

The layer 110 represents the elementary channels. The channels are the means of communication between the modules. The SystemC library comprises three types of channels: the signals (sc_signal, sc_signal_resolved, sc_signal_rv), the buffer memories (sc_buffer) and the FIFO (sc_fifo). The mutex (sc_mutex) and the semaphores (sc_semaphore) are, for their part, means of synchronization for the channels. These channels may be used individually or may be combined in order to create more complex communication mechanisms. The SystemC signals represent the wires of the hardware system. At the instantiation of a channel, the type of data transported must be specified (e.g. sc_bit, etc.). The channels are used inside of a module for the communication between two processes, or else between modules via a port of the module.

The processes describe a functionality or a behavior of the system. The processes in the modules are able to access the channels via the ports of the modules. The main program itself defines the declaration of the summit of the hierarchy of the modules, and other parameters such as the time resolution. The SystemC simulation engine can call or trigger a process upon certain particular events. The events which trigger a given process are those which are defined in the sensitivity list for these processes. A process disposes of a sensitivity list describing the events to which it must react. The processes access the external channels via the ports of their module.

An event is an object of the class sc_event which has neither duration nor value. A notification indicates the modification of an event. Each event keeps a list of the processes which are sensitive to it. When an event is notified, it indicates to the SystemC sequencer the processes to be executed during the next evaluation phase. In SystemC, an occurrence of an event can be notified in three different ways to the sequencer:

immediately, in which case this is called an “immediate notification”;

after a zero time delay, in which case this is called a “delta notification”;

or, after a non-zero time delay, in which case this is called a “timed notification”.

In the following part of the description, the terms “process”, “port”, “channel”, “signal”, “buffer” will be used with reference to the corresponding SystemC elements as described hereinbefore.

The layer 112 represents the model created by means of the elements of the SystemC library. A model written in SystemC is a C++ program which must be compiled in order to generate a virtual prototype.

FIG. 2A shows the conventional method of sequencing of the SystemC kernel (layer 102). The SystemC kernel comprises a sequencer responsible for controlling the time, the order of execution of the processes and the notifications of the events. The order of execution of the processes is undetermined but deterministic. The SystemC kernel, according to the prior art, comprises five main and sequential phases: the phase for evaluation of the SystemC processes (21), the phase for immediate notification (22), the update phase (24), the phase for delta notification (25) and the phase for timed notification (27). The steps from 21 to 26 form a delta-cycle. The steps 21 to 28 form a simulation cycle.

After the initialization and the setup of the simulator (phase 20), all the SystemC processes are executed in no particular order during the evaluation phase 21. During this evaluation phase, all the processes present in a queue are evaluated. Each of the processes can write onto channels, notify an event to wake up other dependant processes (immediate notification) or generate a timed event (timed notification). An immediate notification has the effect of positioning the sensitive processes into the waiting list during the phase for immediate notification 22. Thus, if after the evaluation and immediate notification phase, the queue of processes to be evaluated (23) is not empty, the evaluation phase is re-launched once more.

When the queue 23 is finally empty, the update phase 24 is executed. This phase consists in updating all the SystemC linking elements (for example, SystemC signals or buffers) that have been modified during the various successive evaluation phases. When a linking element is updated and where the new value is different from the preceding one, a delta notification is generated.

In the present description, the expression “linking elements” is used to denote the generic primitives of the grammar of the hardware description language allowing the time-dependent or non-time-dependent point-to-point communications to be modeled, like for example the signals (such as “sc_signal”, “sc_signal_resolved”, “sc_signal_rv”), or the buffers (“sc_buffer”) in the SystemC hardware description language.

At the end of the update phase 24, the delta notification phase 25 begins. It consists in putting all the processes sensitive to the events associated with delta notifications in the queue of processes to be evaluated. Typically, the writing of a SystemC linking element (e.g. signal or buffer) generates this type of notification and all the processes sensitive to this linking element will subsequently be evaluated.

If the queue is not empty (26), the evaluation phase is then re-launched followed by all the other associated phases. These steps are iterated until the queue is empty after the delta notification phase. Lastly, the timed notification phase 27 takes place. It consists in requesting the evaluation of sensitive processes on time-dependent events, and then in updating the simulation iteration number. Generally speaking, the SystemC simulation is terminated (29) when the simulation iteration number reaches the simulation time initially requested.

The conventional update phase of the SystemC kernel allows the concurrence to be expressed at its most precise level. As in any hardware description language, it is important that the states of the SystemC linking elements (e.g. signals, buffers) are only updated at the end of the evaluation. Indeed, all the processes are evaluated sequentially; this solution guarantees that a read of a modified SystemC linking element will return the current value rather than the new value, just like what would happen in modules that were really concurrent. Thus, in the conventional SystemC method for updating the SystemC linking elements, each SystemC linking element has two memory locations: one location for the current value and one location for the new value.

During the evaluation of a sensitive process involving a write onto a SystemC linking element (for example a SystemC signal or buffer), this same SystemC linking element places the new value into the second memory location. A request for an update is subsequently made via the call to a function called “request_update( )”. Similarly, when a write or a read on a FIFO takes place, an update request is made.

It is only when the evaluation and immediate notification phases have ended (i.e. the queue of processes to be evaluated is empty) that the update phase can be executed. The update function “update( )” for each channel having made a call to request_update( ) is then called. For the SystemC linking elements of the signal or buffer type, a copy of the second memory location is made into the first memory location, which has the effect of writing the new value into the current value. When the new value is different from the current value, a delta notification is requested. For the channels of the FIFO type, if a read or a write has taken place, a delta notification is requested. A notification for change of value via a member of the channel of the “sc_event” type is also implemented.

Lastly, after the update phase has finished, the delta notification phase is executed. For each delta notification, using the event of the “sc_event” type, the sensitive processes over these channels are found. This has the effect of putting into the waiting list of processes to be evaluated all the sensitive processes on the events notified during the update phase. Thus, all the sensitive processes over the modified channels will be called during the next evaluation phase.

However, parallel processing or to acceleration would be difficult in such an updating method.

While trying to improve the performance characteristics of the simulation SystemC kernel, the inventors have in particular observed that the conventional update phase of the SystemC kernel had a negative impact on the performance characteristics of the SystemC simulations.

The invention provides a device and a method allowing the update phase of the SystemC kernel to be accelerated. For this purpose, the invention modifies the evaluation phase 21 and the update phase 24 of the conventional sequencing algorithm of the SystemC kernel (layer 102).

FIG. 2B shows the method of sequencing of the SystemC kernel, according to the embodiments of the invention.

According to an advantageous feature of the invention, for each SystemC linking element (e.g. signals or SystemC buffers), two write memory locations (also hereinafter referred to as write buffers) are used for writing the new value whose selection is made according to a selection word (for example a parity bit). Thus, the new value may be written into two separate write buffers, a feature which offers significant advantages with respect to the conventional approach of the SystemC library which uses a single write buffer.

In order to facilitate the understanding of the invention, the following part of the description will be presented with reference to a SystemC linking element of the signal type and to a selection word of the parity bit type, by way of non-limiting example.

In FIG. 2B, numerical references identical to those in FIG. 2A are used to denote certain similar steps.

After the initialization and the setup of the simulator (phase 20), the SystemC processes are executed in no particular order during the evaluation phase 210. During this evaluation phase, all the processes present in a queue are evaluated. According to the invention, the evaluation phase 210 includes a part of the phase for updating the signals. Thus, prior to each read of a signal or write onto a signal, the updating of the signal is carried out. Advantageously, the current value of the signal is updated during the evaluation phase 210 based on one of the two write buffers depending on the value of the parity bit. Finally, if a write operation takes place, the write buffer which is chosen for writing the new value is that which has not been used during the read operation.

The selection of one of the two buffers is made according to the invention by virtue of a parity bit, associated with each signal. In one preferred embodiment of the invention, a single parity bit is individually associated with each signal. According to the value of the parity bit associated with a given signal, one of the two write buffers is selected for writing the new value, whereas the other write buffer will be selected for reading the new value obtained during the preceding evaluation phases after having carried out the update phase in order to update the current value. In one advantageous embodiment, the value of the parity bit remains constant until the update phase is executed. As a complement, when the new value is different from the current value, a delta notification may be requested by means of an update request carried out by calling the function request_update( ).

When the queue is empty (23) after the execution of the immediate notification phase (22), another part of the update phase is executed 240. In this step 240, the parity bits may be modified for each of the signals for which an update request “request_update( )” has been received.

The use of two write buffers thus allows a conformant operation to be guaranteed, and the concurrence to be expressed at its most precise level, while at the same time allowing the update phase to use partial parallel processing. Whereas the conventional update phase is sequential and constitutes a significant extra time cost, the possibility of running the update phase in parallel according to the invention allows a significant reduction in the duration of sequencing and hence in the simulation times.

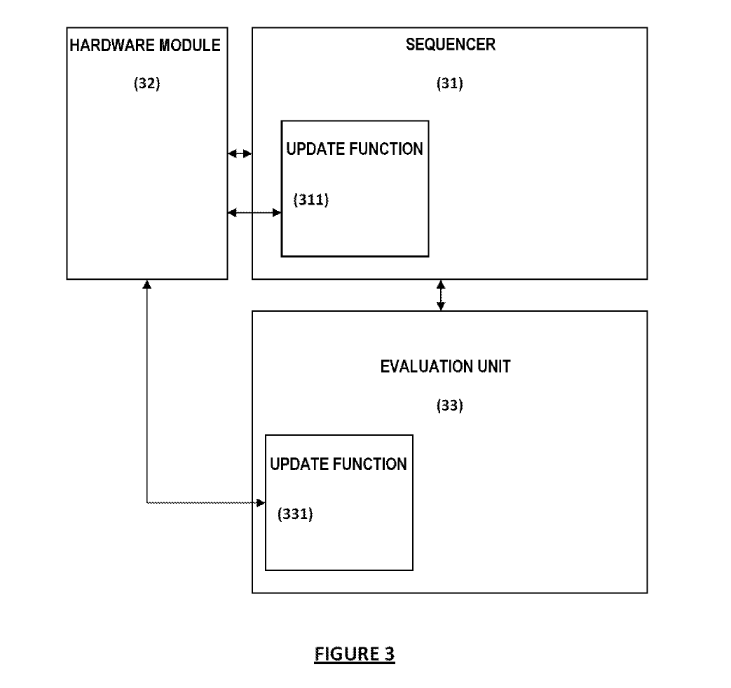

FIG. 3 shows a simulation device 3 according to one embodiment of the invention.

The simulation device 3 executes the simulation of a system described in SystemC. It comprises a sequencer 31 configured for controlling the evaluation of the processes, together with the phases for evaluation 210 and for updating 240 according to the invention. The simulation device furthermore comprises a unit for evaluation of the processes 33 which evaluates the eligible processes selected by the sequencer 31 and a function for updating the signals divided between a first update function 311 within the sequencer 31 and a second update function 331 within the evaluation unit 33.

In FIG. 3, the update function 311 is directly integrated into the sequencer 31. As a variant, it may be separate from the sequencer 31.

The simulation device 3 according to the invention performs a first update step during the evaluation phase whilst writing onto a signal. This first step consists in positioning in one of the write buffers the future value to be used during the evaluation phase which will take place after the update phase. A second update step is carried out by a update hardware module 32. The latter step is carried out during the evaluation phase taking place after the update phase: during a write or read access, the final update is carried out. These three steps are thus combined in order to perform a complete update. According to one advantageous feature of the invention, the parity bit of the signal is used to implement such a combination.

According to one feature of the invention, the sequencer 31 and the update functions 311 and 331 interact with the update hardware module 32. The hardware module 32 is configured for associating a parity bit with each SystemC signal and for updating the parity bits. In one particular embodiment of the invention, the updating of a parity bit consists in inverting its value: thus, if the bit is even, after its update it becomes odd, and vice versa, if the bit is odd, after its update it becomes even.

The sequencer 31 is configured for resetting the hardware module 32 during the initialization step 20 and for requesting the update of the parity bits during the update phase executed by the first update function 311. The second update function 331 uses this parity bit to read or write a signal. Depending on the value of the parity bit, the first write buffer or second write buffer may be selected.

In the existing embodiments, the only potential parallelism of SystemC resides in the phase for evaluation of the processes 210, because all the processes are independent and may be executed in a disordered and concurrent manner. The invention advantageously allows parallel operation of the evaluation phase 210 and a part of the update phase 240 to be integrated into it. The use of two write buffers allows the parallel execution of the update phase 240 with a view to accelerating the SystemC simulations. It guarantees notably that, during the evaluation phase 210, the new written values do not modify the current values, which is essential for the modeling of the concurrence.

The invention is thus based on a hybrid solution for updating that can involve both software elements (the first and the second update function 311 and 331) and hardware elements (hardware module 32) for accelerating the update phase of the SystemC kernel, on the basis of a parity mechanism and of two write buffers. According to the invention, the second update function 331 incorporates the part of the update phase which can use parallel processing, the first update function 311 incorporates the initialization of the hardware module, whereas the hardware module 32 accelerates the part of the update operation which cannot be processed in parallel.

In the embodiment shown in FIG. 3, the hardware module 32 is separate from the sequencer 31. As a variant, the hardware module 32 may be integrated into the sequencer 31 or evaluated using software. It should be noted that, in the embodiment where the module 32 is separate from the sequencer 31, a better acceleration has been observed.

During the initialization of each signal (“step 20” in FIG. 2B), the request for updating the identifier of the signal “get_update_signal_id( )> is sent to the hardware module 32 by the sequencer 31. In response to this request “get_update_signal_id( )”, the hardware module 32 returns a unique identifier denoted hereinafter by m_signal_id. This identifier is then associated with the SystemC object throughout the simulation. According to the present invention, this identifier is used by the second update function 331 in order to dialog with the hardware module 32.

The hardware module 32, according to the invention, interacts with the update functions 311 and 331 according to at least four types of requests:

in response to the reception of a request, written “get_update_signal_id( )”, for the initialization of the identifier of a given signal, the hardware module 32 determines the unique identifier of the signal and returns it to the first update function 311;

in response to the reception of a request, written “get_signal_parity( )”, in order to supply the parity bit of a given signal, the update hardware module 32 determines the parity bit of said signal and returns it to the second update function 331;

in response to the reception of a request, written “push_update_request( )”, for the request for updating the parity bit of a given signal, the update hardware module 32 saves the request for updating the parity of said signal; and

in response to the reception of a request, written “update( )”, for the updating of the parity bits, the hardware module 32 updates the parity bits of all the signals having received an update request.

Each signal disposes of a variable for storing its current value written “m_value”. This value may be read or written by a process during the evaluation phase 210. According to the present invention, each SystemC signal is furthermore associated with two write buffers, a first write buffer which will be denoted hereinafter m_next_value_even and a second write buffer which will be denoted hereinafter m_next_value_odd. Depending on the current value of the parity bit that the hardware module 32 returns for the given signal, one of the two buffers is selected for updating or reading the value of the signal during the evaluation of a process.

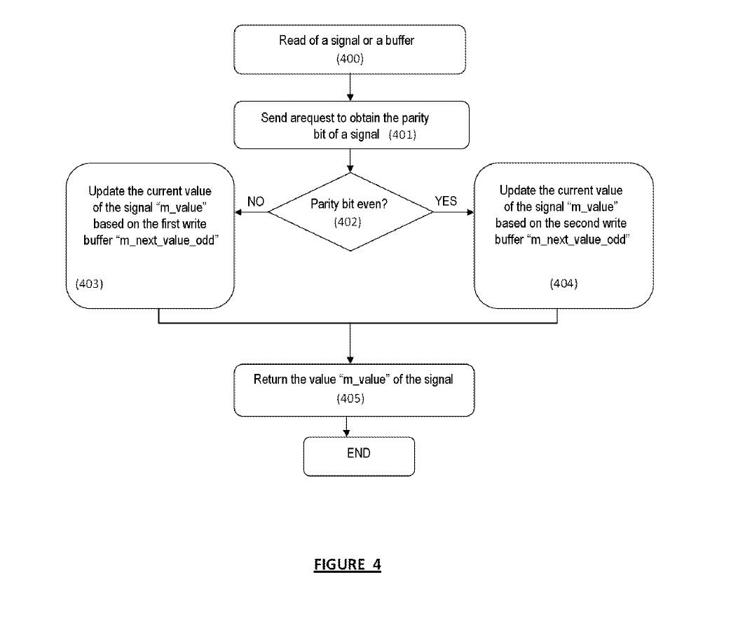

FIG. 4 is a flow diagram showing the various steps implemented by the second update function 331 for updating a signal during the evaluation of a process that reads the signal.

The reading of a signal begins by the updating of its current value.

According to the invention, the updating of the signals is carried out during the evaluation phase 210, notably by means of the update function 331, which allows the parallel processing of the update phase. Once the update has been done, the current value can then be returned.

During the reading (step 400) of the current value “m_value” of a signal that can be involved in the evaluation phase 210, a first part of the update phase first of all takes place, in the steps 401 to 405.

More precisely, at the step 401, a request “get_signal_parity( )” is sent to the hardware module 32 in order to obtain the current parity bit of the signal. The identifier of the signal received in the initialization phase 20 is passed as a parameter of this request and is used by the update hardware module 32 in order to recover the information.

At the step 402, it is determined whether the current parity bit returned by the hardware module 32 is even. If the current parity bit is even, at the step 403, the current value m_value of the signal is updated from the value m_next_value_even of the first write buffer (also denoted hereinafter by “even buffer”): “m_value=m_next_value_even”.

Otherwise, if the parity bit current is odd, at the step 404, the current value of the signal is updated using the value m_next_value_odd of the second write buffer (also denoted hereinafter by “odd buffer”): “m_value=m_next_value_odd”.

At the step 405, the current value of the signal is returned according to the SystemC standard.

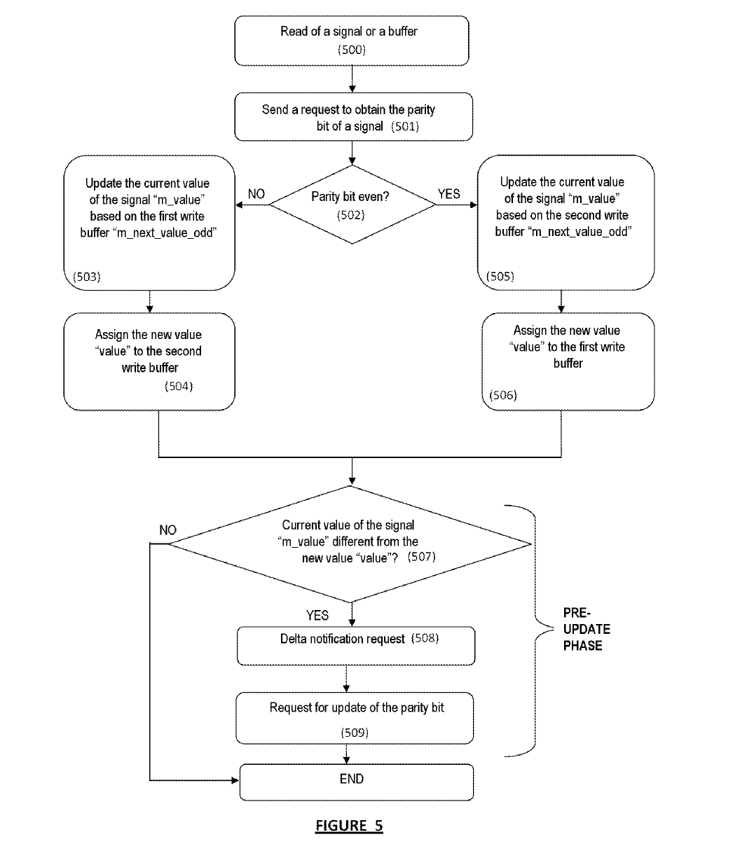

FIG. 5 is a flow diagram showing the various steps implemented by the second update function 331 for updating a signal during the evaluation of a process which writes onto the signal.

The writing of a signal also begins by the updating of the current value, in contrast to the conventional update phase. The updating of a signal according to the invention is also carried out during the evaluation phase, by means of the second update function 331, which allows parallel processing of the update phase. Once the update has been carried out, the new value is written into one of the two write buffers which has not been used for the read. In the case of writing a new value, a delta notification request is generated for evaluating the sensitive processes on the signal. A request for updating the parity bit is subsequently sent to the hardware module 32.

During the write operation (step 500) of a signal able to participate in the evaluation phase, a request “get_signal_parity( )” is sent to the hardware module 32 in order to obtain the current parity bit of the signal at the step 501. The step 502 determines whether the current parity bit received from the hardware module 32 is even. If the current parity bit is even, at the step 503, the current value m_value of the signal is updated from the value m_next_value_even of the first write buffer (or even buffer): “m_value=m_next_value_even”.

At the step 504, the new value of the signal written “value” is written into the second write buffer m_next_value_odd (odd buffer): “m_next_value_odd=value>>.

Conversely, if the current parity bit is odd, the current value m_value of the signal is updated at the step 505 from the value m_next_value_odd of the second write buffer (odd buffer): “m_value=m_next_value_odd>>.

The new value of the signal is written into the first write buffer (even buffer) m_next_value_even at the step 506: “m_next_value_even=value”.

At the step 507, it is determined whether the new value of the signal is different from the current value of said signal: “value !=m_value”.

If the new value of the signal is different from its current value, a delta notification request is sent at the step 508 in order that the evaluation of the SystemC processes sensitive to this signal is requested.

At the step 509, a request for modification of the parity bit is sent to the hardware module 32 by means of the update request “push_update_request( )”. The identifier of the signal m_signal_id is passed as a parameter of this update request. The hardware module 32 uses the identifier of the signal for updating the parity bit. The updating of the parity bit is carried out in the hardware module 32 upon the request of the sequencer 31. In one preferred embodiment of the invention, the updating of a parity bit consists in inverting its value: an even bit becomes odd, and an odd bit becomes even.

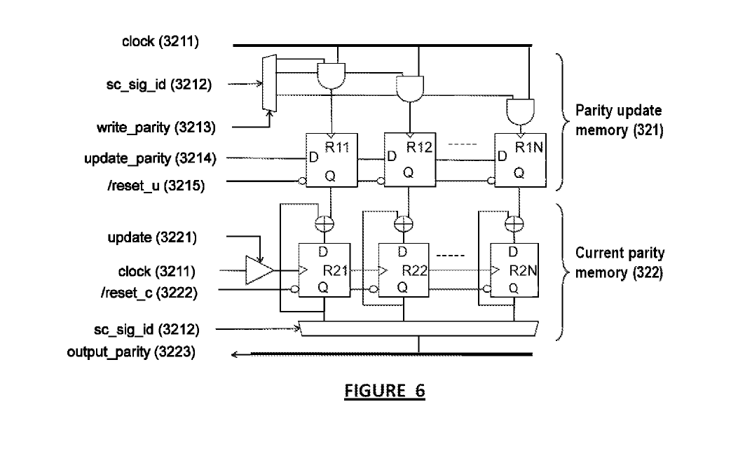

FIG. 6 shows one embodiment of the hardware module 32, according to the invention. The hardware module 32 comprises a counter (not shown), together with a first storage block for the parity update 321 and a second storage block for the update of the current parity 323.

The hardware module 32 notably has the function of inverting the parity bits of the signals having been modified during the evaluation phase. More generally, it allows the management of the updating of the selection of one of the two write buffers.

The counter is configured for returning unique identifiers in response to the requests “get_update_signal_id( )” sent by the sequencer 31 during the initialization of the signals.

The first storage block 321, also called parity update memory, is configured for updating the parity bit of a signal, in response to a request “push_update_request( )” identifying this signal. The second storage block 322, also called current parity memory, is configured for determining the current parity bit of a signal in response to a request “get_signal_parity( )” identifying this signal, and for returning this current bit.

The first storage block 321 can be composed of a series of N registers R11, R12, . . . etc., R1N. Similarly, the second storage block 322 can be compose of a series of N registers R21, R22, . . . etc., R2N. In the embodiment shown in FIG. 6, the number of registers in the two storage blocks 321 and 322 is equal, and the registers are independent from one another. Furthermore, a set of two registers R1i and R2i corresponds to each signal. The two registers R1i and R2i associated with a given signal are connected together in such a manner that the output Q of the register R1i is connected to the input D of the register R2i. In particular, the total number of signals that can be instantiated is equal to the number of registers N for each of the storage blocks 322 and 321.

Advantageously, at the initialization, the update hardware module 32 resets the content of the registers R1i and R2i to 0 via two reset control signals “/reset_c” (3222) and “/reset_u” (3215) respectively associated with the storage blocks 321 and 322.

In response to the reception of a request “get_signal_parity( )”, sent by the second update function 331, the current parity memory 322 returns the current parity value of the signal. For this purpose, a parameter “sc_sig_id” (3212) is given as a parameter of the request. This parameter “sc_sig_id” represents the unique identifier of a signal which has been obtained during the initialization by the update function 311. The parameter “sc_sig_id” (3212) will then select the correct column in the current parity memory 322, or else the register R2i associated with said signal. The result of the content of the register R2i selected from the two storage block 322, also known as current parity memory, is then present on the output “output_parity” (3223). It is finally transferred to the update function (331).

In response to the reception of a request “push_update_request( )”, sent by the update function (331), the logical value 1 is written into the register R1i corresponding to said signal of the parity update memory 321. For this purpose, a parameter “sc_sig_id” (3212) representing the unique identifier of a signal, obtained during the initialization by the update function (311), is given as a parameter of the request. This parameter “sc_sig_id” (3212) will select the correct column in the update memory for the parity 321, or else the register R1i associated with the signal. A control signal, denoted by “write_parity” (3213), is provided for controlling the writing of the parity bit into the register R1i selected by the unique identifier of the signal. In response to the reception of the request, the control signal “write_parity” (3213) is set to 1. Substantially at the same time, the signal for updating the parity bit denoted by “update_parity” (3214) is also set to 1. The setting to 1 of these two control signals (3213) and (3214) has the effect of writing the logical value 1 into the selected register R1i of the parity update memory (321).

During the update phase, the sequencer 31 sends a request “update” to the hardware module 32, which has the effect of writing the logical value 1 onto the control signal “update” (3221). The setting to 1 of the signal “update” (3221) has the effect of performing in parallel an “exclusive OR” of the contents of the registers of the same column of the party update memory 321 and of the current parity memory 322, in other words an “exclusive OR” between the registers R1i and R2i. Thus, if the value of the register R1i of the update memory for the parity 321 is at 1, the value of the register R2i of the current parity memory 322 is inverted: it becomes equal to 0 if it was at 1, and becomes equal to 1 if it was equal to 0. In contrast, if the value of the register R1i of the update memory for the parity 321 is at 0, the content of the register R2i of the current parity memory 322 is unchanged.

Thus, the activation of the signal “update” (3221) allows the current parity of all the SystemC signals whose value has been modified during the evaluation phase 210 to be changed in a few cycles. The simulation kernel according to the invention thus allows an update, in a very short time, of the parity bits of the SystemC signals modified during the evaluation phases. This contributes to greatly reducing the simulation times. The independent use of two memories, one for storing the requests for updating the parity bit, the other for storing the current values of the parity bits, furthermore allows a parallel evaluation of the update phase and allows it to be ensured that the current parity value will only be modified after the update phase. Finally, the use of elementary logical elements (register, exclusive OR gate, etc.) guarantees a very low complexity and hardware surface area.

By significantly accelerating the SystemC kernel, the invention allows the performance characteristics to be enhanced for the functional verification, the architectural exploration, the software/hardware partitioning, the validation of the applications and, more generally, for the design of complex systems.

These advantages are even more significant when the simulations are executed by data processors capable of efficiently supporting a parallel execution of the SystemC processes. Numerous advances are underway in this field. In conjunction with functions for parallel processing, the SystemC kernel according to the invention allows the current limits for use of the software prototyping tools to be pushed back while at the same time conserving a high precision, including in the application development. Furthermore, it allows the architectural exploration to be substantially accelerated, thus making possible a greater number of optimizations in an identical design time.

The invention has been described in relation with the updating of a SystemC linking element of the signal or buffer type, by way of non-limiting example. It is applicable in a similar manner to the updating of any linking element requiring an update after evaluation, such as for example any channel combining signals or buffers, or else on the ports used for connecting modules together. More generally, the invention is applicable in an identical fashion to any hardware description language other than SystemC which requires a step for updating elements of its grammar only after the end of the evaluation phase (phase containing the reading and writing operations of these elements).

The invention is not limited to the embodiments described hereinbefore by way of non-limiting examples. It encompasses all the variant embodiments which could be envisioned by those skilled in the art. In particular, although the invention offers certain advantages for a selection word of the parity bit type, it is applicable to any type of selection element such as for example a word of several bits (e.g. 16 or 32 bits). Nor is the invention limited to the arrangement of logical elements shown in FIG. 6. Furthermore, the update hardware module 32 has been described as an additional element of the architecture. As a variant, it may be integrated into the memory manager of the architecture, an element that exists in any data processor needing a dynamic management of the memory.

1. A method for accelerating the updating of the linking elements in a simulation of a system generated according to a given hardware description language, said method comprising a phase for evaluation of the eligible processes of the system, said evaluation phase comprising write or read access to linking elements, wherein, for each linking element two write memory locations are initially provided, and wherein said evaluation phase comprises the updating of a linking element for each write or read access of said linking element, said update comprising the following steps:
receive a selection word associated with said linking element;
select one of the two write locations associated with said linking element depending on the value of the selection word received for said linking element; and
update the current value of said linking element based on the selected write memory location.

2. The method as claimed in claim 1, wherein the selection word is a parity bit.

3. The method as claimed in claim 1, wherein the updating of the linking elements is carried out in parallel during the evaluation phase.

4. The method as claimed in claim 1, further comprising requests for a change of state of the selection words associated with the linking elements, said requests being carried out in parallel during the evaluation phase.

5. The method as claimed in claim 1, wherein the selection words associated with the linking elements remain constant during the evaluation phase.

6. The method as claimed in claim 1, wherein for an access to a linking element of the read type, the updating of the linking element comprises the following steps:
receive the value of the selection word for the linking element,
update the current value of the linking element from a write memory location determined according to the value of the selection word received, and
return the new current value.

7. The method as claimed in claim 1, wherein for an access to a linking element of the write type, the step for updating said linking element comprises the following steps:
receive the value of the selection word for the linking element,
update the current value of the linking element from a write memory location determined according to the value of the selection word received,
write the new value of the linking element in the write memory location distinct from the write memory location determined according to the value of the selection word received.

8. The method as claimed in claim 7, further comprising a request for delta notification for the evaluation of the sensitive processes on said linking element if the new value of the linking element is different from the current value of the linking element.

9. The method as claimed in claim 7, further comprising the generation of a request for updating the selection word associated with said linking element.

10. The method as claimed in claim 1, wherein the step for updating the selection word comprises an update of the selection word to a value opposite to that of the selection word.

11. The method as claimed in claim 1, wherein the hardware description language is SystemC.

12. The method as claimed in claim 11, wherein the linking elements comprise at least one from amongst the following SystemC elements: signals “sc_signal”, signals “sc_signal_resolved”, signals “sc_signal_rv”, buffer memories “sc_buffer”.

13. A device for accelerating the updating of the linking elements in a simulation of a system generated according to a given hardware description language, said device comprising a phase for evaluation of the eligible processes of the system, said device comprising an evaluation unit for evaluating processes, said evaluation comprising write or read accesses for linking elements, characterized in that the device comprises two write memory locations for each linking element, and in that the evaluation unit comprises, in response to a read or write access for a linking element, a call to an update function designed to update said linking element, said update function being configured for:
receiving a selection word associated with a linking element to be modified;
selecting one of the two write locations associated with said linking element depending on the value of the selection word received for said linking element; and
updating the current value of said linking element based on the selected write memory location.

14. The device as claimed in claim 13, further comprising a hardware module configured for delivering the selection word associated with each linking element and for updating the selection words.
